(19) United States
(12) Patent Application Publication
(10) Pub. No.: US 2026/0320098 A1
(43) Pub. Date: Oct. 15, 2026

(54) ANTI-HALLUCINATION SYSTEM FOR LARGE LANGUAGE MODELS

(71) Applicant: Ankush Sharma, San Jose, CA (US)

(72) Inventor: Ankush Sharma, San Jose, CA (US)

(21) Appl. No.: 19/323,610

(22) Filed: Sep. 9, 2025

Related U.S. Application Data
(60) Provisional application No. 63/718,086, filed on Nov. 8, 2024.

(51) Int. Cl. G06F 16/334; G06F 16/332

(52) U.S. Cl. CPC G06F 16/3344; G06F 16/3326

(57) ABSTRACT

A system and computer program product address the phenomena of hallucinations occurring in large language models. Embodiments include a module that performs fact-checking against external sources so that information is accurate and mitigates the propagation of misinformation that may occur in future requests. Another module detects contradictions in the language of responses so that information is consistent. Another module implements confidence scoring in responses generated by LLMs so that end users have a gauge to assess the validity of a response from an LLM query. Some embodiments include calibration of the hallucination checking modules so that future instances remain accurate.

### CROSS-REFERENCE TO RELATED APPLICATIONS

None.

### BACKGROUND

The embodiments herein relate generally to machine learning, and more particularly, an anti-hallucination system for large language models.

Hallucinations are the events in which machine learning (ML) models, particularly large language models (LLMs) like GPT-3 or GPT-4, produce outputs that are coherent and grammatically correct but factually incorrect or nonsensical.

Hallucinations may cause several different types of problems because of the nature of LLMs. For example, hallucinations can be discriminating and produce toxic content: LLMs build knowledge on online data (biased in most cases), resulting in outputs that endorse incorrect stereotypes, harmful dialogue, and hurtful opinions. Hallucinations may create privacy issues. An LLM is prone to privacy violations as they may contain personal information about individuals. LLMs can inadvertently propagate misinformation and spread inaccurate information. In some cases, hallucinations propagate false narratives.

### SUMMARY

In one aspect of the disclosure, a system and computer program product address the phenomena of hallucinations occurring in large language models. Embodiments include a module that performs fact-checking against external sources so that information is accurate and mitigates the propagation of misinformation that may occur in future requests. Another module detects contradictions in the language of responses so that information is consistent. Another module implements confidence scoring in responses generated by LLMs so that end users have a gauge to assess the validity of a response from an LLM query. Some embodiments include calibration of the hallucination checking modules so that future instances remain accurate.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of an architecture for combating hallucinations in large language models, accordance with an exemplary embodiment of the subject disclosure.

FIG. 2 is a flowchart of a method of fact checking external sources in accordance with an exemplary embodiment of the subject disclosure.

FIG. 3 is a flowchart of a method for detecting contradictions accordance with an exemplary embodiment of the subject disclosure.

FIG. 4 is a diagrammatic view of a process for scoring confidence in a large language model, accordance with an exemplary embodiment of the subject disclosure.

### DETAILED DESCRIPTION OF CERTAIN EMBODIMENTS

Broadly, embodiments of the subject technology provide a system and methods that detect and prevent hallucinations in large language models. Aspects of the subject technology address hallucination in Large Language Models (LLMs) using fact-checking against external sources, contradiction detection, and implementing confidence scoring and calibration. The subject technology performs fact-checking in real-time and assesses the consistency of the LLM's responses, while also providing confidence scores to gauge the reliability of its output. By following this approach, the system would reduce hallucination by verifying facts, checking for contradictions, and offering calibrated confidence scores for each output. This method increases the reliability of responses from LLMs and can be applied to any system that relies on large language models.

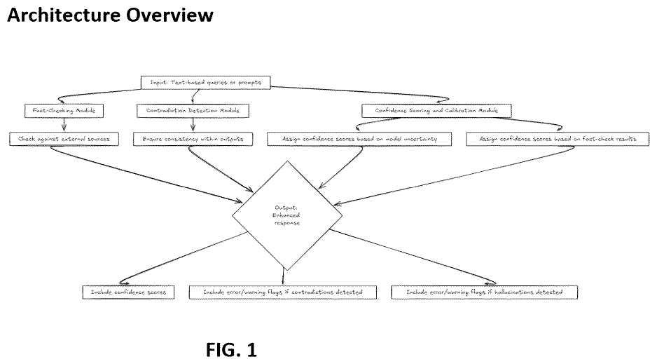

Referring now to FIG. 1, an architecture for combatting hallucinations in LLMs is shown. The system receives input from text-based queries or prompts, which generally trigger some request for output from a LLM. The modules that monitor the LLM for hallucinations include:
A Fact-Checking Module, which checks generated responses against external sources.
A Contradiction Detection Module, which ensures consistency within generated outputs.
A Confidence Scoring and Calibration Module, which assigns confidence scores based on model uncertainty and fact-check results.

The output from the LLM after the above listed modules are operated provides an enhanced, fact-checked response with confidence scores and error/warning flags if contradictions or hallucinations are detected.

The following provides additional detail associated with each of the processes invoked by the modules described above.

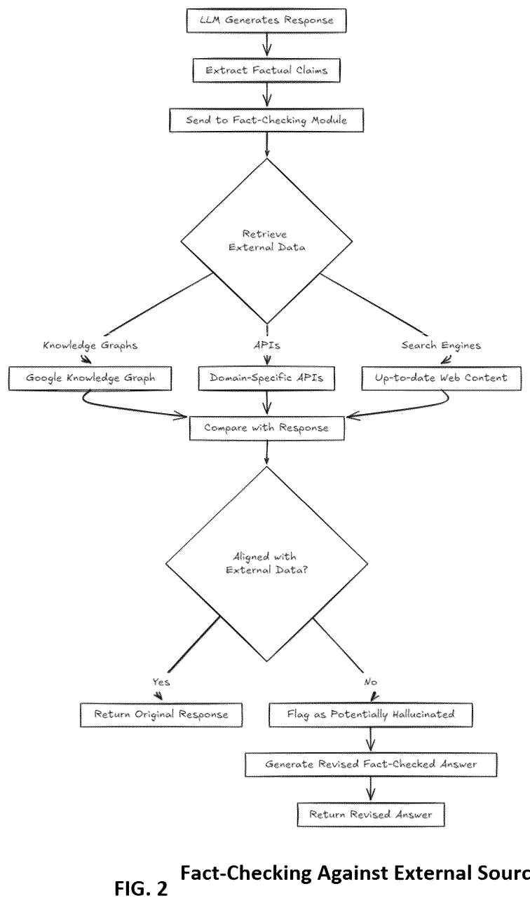

FIG. 2 shows a method associated with fact checking external sources. The fact-checking module retrieves data from reliable external sources, such as:
Knowledge Graphs (e.g., Google Knowledge Graph, Wikidata)
APIs for specific domains (e.g., medical data, financial data)
Search Engines (to retrieve up-to-date web content) In operation, the module sends parts of the generated output (particularly factual claims) to the fact-checking module, when an LLM generates a response to input. External data is retrieved using APIs or search engines. The module retrieves relevant information from trusted sources. The module compares the generated response with the retrieved external sources. If the response does not align with verified data, it is flagged as potentially hallucinated, and a revised fact-checked answer is returned.

Technologies Involved:
OpenAI GPT for natural language generation (input/output handling).
Wikidata API or Google Knowledge Graph for external fact-checking.
Natural Language Processing (NLP) tools to extract facts from text.

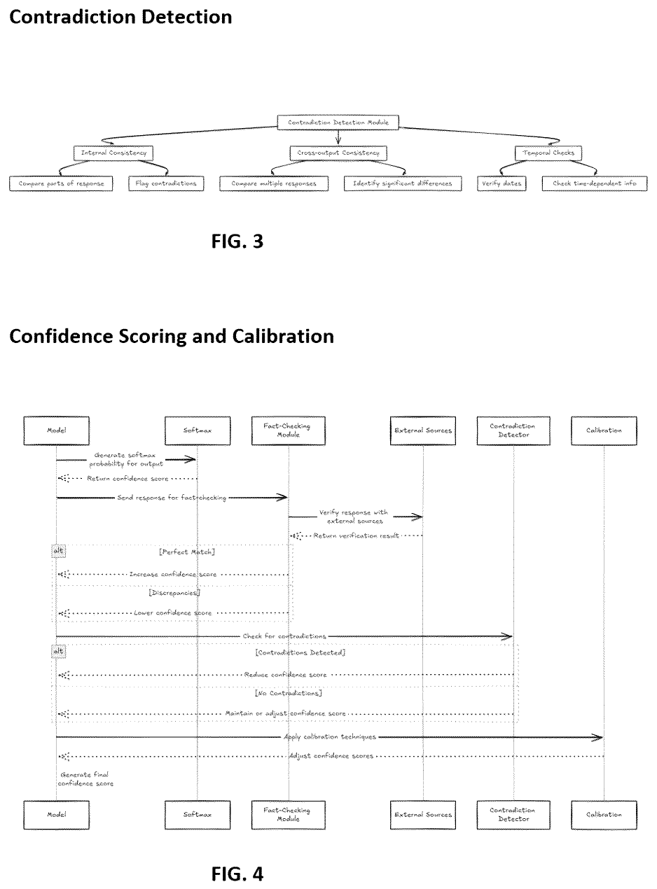

FIG. 3 shows a method of detecting contradictions in LLM responses. This module focuses on ensuring consistency within the generated response or across multiple outputs generated from the same input. In operation, the module compares different parts of the response for contradictions. For example, if the LLM provides a historical fact in one part of the answer and contradicts it later, it will be flagged. Accordingly, internal consistency is achieved. If the same query is asked multiple times, the responses are compared for consistency. Any significant differences can indicate hallucination. Temporal checks may be performed. Dates and time-dependent information may be verified to ensure that facts align with the known timeline.

Technologies involved:
Natural Language Inference (NLI) models to detect contradictions.
NLP libraries like SpaCy or AllenNLP for detecting semantic inconsistencies.

FIG. 4 shows a method for generating confidence scoring and calibrating the system. This module assigns a confidence score to each generated response based on several factors:
Model's inherent confidence: Many LLMs can generate a softmax probability distribution that represents their certainty in a given output.
Fact-checking accuracy: If the fact-checking module confirms the response matches external sources, the confidence score is increased. Otherwise, it's lowered.
Contradiction flags: If contradictions are detected, the score is reduced.
Calibration: Adjusting confidence scores based on performance over time (e.g., Bayesian calibration).

In operation, the module assigns a score to each response based on model confidence. Fact-check feedback may be performed by adjusting the score based on fact-checking results. A perfect match with external sources increases confidence, while discrepancies lower it. If contradictions are found, the confidence score may be lowered accordingly. In some embodiments, calibration of the confidence scoring process may be applied using techniques, such as Platt scaling or temperature scaling, to better align model confidence with actual accuracy.
Technologies involved;
Softmax probability outputs from LLM models.
Platt scaling or temperature scaling algorithms for score calibration.
Scikit-learn for calibration algorithms

As will be understood, the modules and processes described above may generally be implemented using a computing device, which may be a personal computer or a server hosted by a platform. The computing device may be general purpose computing devices which may include, but are not limited to, one or more processors or processing units, a system memory, and a bus that couples various system components including the system memory to the processor as is known in the art of computers. The computing device operability may be described in the general context of computer system executable instructions, such as program modules, being executed by a computer system. In some embodiments, the computing device performing detection, prevention, and confidence scoring associated with hallucinations in LLMs may be a cloud computing node connected to a cloud computing network (not shown) and practiced in distributed cloud computing environments where tasks are performed by remote processing devices that are linked through a communications network. In a distributed cloud computing environment, program modules may be located in both local and remote computer system storage media including memory storage devices.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system) may be utilized. In the context of this disclosure, a computer readable storage medium may be any tangible or non-transitory medium that can contain, or store a program (for example, the program product) for use by or in connection with an instruction execution system. apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above. Also, the addition of powered sub-woofers to augment an embodiment will not invalidate the claims of this invention.

What is claimed is:

1. A system for computationally mitigating hallucinations in text generated by a large language model (LLM), the system comprising:
one or more hardware processors; and
a non-transitory computer-readable memory storing instructions that, when executed by the one or more hardware processors, cause the system to:
receive a text-based query;
process the query through the LLM to generate a primary response;
parse the primary response to identify a factual segment using a named entity recognition (NER) model;
generate a query vector by encoding the factual segment using a first sentence embedding model;
retrieve, via an application programming interface (API) call, evidentiary data from a structured external knowledge source;
generate an evidence vector by encoding the evidentiary data using a second sentence embedding model;
compute a factual accuracy score by calculating a cosine similarity between the query vector and the evidence vector;
analyze the primary response for semantic inconsistencies using a transformer-based natural language inference (NLI) model trained on premise-hypothesis pairs;
generate a calibrated confidence score for the primary response by combining the factual accuracy score with an output from the NLI model, wherein the calibrated confidence score is adjusted using a Platt scaling calibration technique;
and
generate and output a structured data object comprising:
(i) the primary response,
(ii) the calibrated confidence score, and
(iii) a hallucination indicator indicating whether the calibrated confidence score is below a predetermined threshold.

2. The system of claim 1, wherein the structured external knowledge source is selected from the group consisting of: a knowledge graph API, a domain-specific database API, and a scientific journal API.

3. The system of claim 1, wherein the instructions further cause the system to:
based on the hallucination indicator being set, automatically trigger regeneration of a revised response by submitting a modified prompt to the LLM, the modified prompt comprising the original query concatenated with the evidentiary data.

4. The system of claim 1, wherein the first sentence embedding model and the second sentence embedding model are the same model.

5. The system of claim 1, wherein the NLI model is further fine-tuned on a dataset of hallucination examples synthesized from LLM outputs.

6. The system of claim 1, wherein the structured data object is a JavaScript Object Notation (JSON) object.

7. The system of claim 6, wherein the JSON object further comprises a field containing the evidentiary data used to compute the factual accuracy score.

8. The system of claim 1, wherein the instructions further cause the system to:
prior to processing the query, perform a context-aware decomposition of the query to identify a domain and intent associated with the query.

9. The system of claim 8, wherein the instructions to retrieve evidentiary data cause the system to select the structured external knowledge source based on the identified domain.

10. The system of claim 1, wherein the instructions further cause the system to:
cause a graphical user interface to display the primary response with a visual highlight applied to the factual segment, wherein a color of the highlight is determined by the factual accuracy score.

11. A computer-implemented method for computationally mitigating hallucinations in text generated by a large language model (LLM), the method comprising:
receiving, by one or more hardware processors, a text-based query;
processing, by the one or more hardware processors, the query through the LLM to generate a primary response;
parsing, by the one or more hardware processors, the primary response to identify a factual segment;
generating, by the one or more hardware processors, a query vector by encoding the factual segment;
retrieving, by the one or more hardware processors via an API call, evidentiary data from a structured external knowledge source;
generating, by the one or more hardware processors, an evidence vector by encoding the evidentiary data;
computing, by the one or more hardware processors, a factual accuracy score by calculating a semantic similarity between the query vector and the evidence vector;
analyzing, by the one or more hardware processors, the primary response for semantic inconsistencies using a natural language inference (NLI) model;
generating, by the one or more hardware processors, a calibrated confidence score for the primary response based on the factual accuracy score and a result from the analyzing step; and
generating and outputting, by the one or more hardware processors, a structured data object comprising the primary response, the calibrated confidence score, and a hallucination indicator.

12. The method of claim 11, wherein calculating the semantic similarity comprises computing a cosine similarity in a high-dimensional embedding space.

13. The method of claim 11, wherein the calibrated confidence score is generated by an adaptive weighted combination of the factual accuracy score, a contradiction probability output from the NLI model, and a native confidence score of the LLM.

14. The method of claim 11, further comprising:
calibrating the calibrated confidence score using a temperature scaling technique to align the score with an empirical accuracy probability.

15. The method of claim 11, further comprising:
based on the hallucination indicator, automatically triggering regeneration of a revised response by submitting a modified prompt to the LLM, the modified prompt incorporating the evidentiary data as grounding context.

16. The method of claim 11, further comprising:
causing a graphical user interface to display the primary response with a visual highlight overlay on the factual segment, wherein a color of the highlight is determined by the factual accuracy score.

17. The method of claim 11, wherein the structured data object is a JavaScript Object Notation (JSON) object.

18. A non-transitory computer-readable storage medium storing instructions that, when executed by one or more processors of a computing system, cause the computing system to perform operations comprising:
receiving a text-based query;
processing the query through a large language model (LLM) to generate a primary response;
identifying one or more factual claims within the primary response;
for each factual claim of the one or more factual claims:
querying one or more external data sources to retrieve evidentiary data;
generating a factual accuracy score based on a comparison between the factual claim and the evidentiary data;
analyzing the primary response to detect semantic inconsistencies using a natural language inference (NLI) model;
generating a confidence score for the primary response based on a combination of the factual accuracy score and a result of the analyzing for semantic inconsistencies; and
outputting an enhanced response object comprising the primary response, the confidence score, and an indicator based on the factual accuracy score.

19. The non-transitory computer-readable storage medium of claim 18, wherein the instructions for generating the confidence score further cause the computing system to generate an explanatory output indicating a contribution of factual inaccuracy and semantic inconsistency to the confidence score.

20. The non-transitory computer-readable storage medium of claim 18, wherein the instructions further cause the computing system to:
trigger an automatic regeneration of the primary response using a modified prompt that incorporates the evidentiary data when the confidence score falls below a predetermined threshold.
